(19) United States
(12) Patent Application Publication
(10) Pub. No.: US 2024/0235581 A1
(43) Pub. Date: Jul. 11, 2024

(54) Signal receiving device, communication system and signal receiving method

(71) Applicant: Tianjin LinkRV Technology Co., LTD, Tianjin (CN)

(72) Inventor: Lihua Weng, Tianjin (CN)

(21) Appl. No.: 18/150,974

(22) Filed: Jan. 6, 2023

(51) Int. Cl. H04B 1/00; H04B 1/06

(52) U.S. Cl. CPC H04B 1/005; H04B 1/06

(57) ABSTRACT

The invention relates to a signal receiving device, a communication system and a signal receiving method, wherein the signal receiving device is provided with a receiving mode Block, the filter, the second filter, frequency offset estimation and frequency offset compensation module, receiving signal by receiving module, and then the first filter to filter to get the first signal of communication signals, the second filter to filter to get the second signal of communication signals, whose second filter band width less than the first frequency bandwidth of the filter, So because of the second filter band width is narrower, the second signal noise less than the first signal of noise, therefore the frequency offset estimation module through to the second signal frequency offset estimation, the deviation estimates more accurate, final deviation compensation module based on the frequency offset estimation value of the first signal compensation precision is higher.

### Field of the Invention

The invention relates to the field of communication technology, in particular to a signal receiving device, a communication system and a signal receiving method.

The star chart of the sixth generation wireless network WiFi 6 is as high as 1024QAM(the star chart of WiFi 5 is only 256QAM), but the subcarrier interval is only a quarter of that of WiFi 5. Therefore, the accuracy of frequency offset estimation requirements of WiFi 6 is much higher than that of WiFi 5.

For the receiver in the communication system, the frequency deviation will cause the overall performance loss of the receiver. Generally, after frequency offset compensation, the influence of frequency offset will be suppressed. However, due to the influence of channel environment and noise, frequency offset compensation may not be accurate, which ultimately affects the performance of the receiving end, especially for systems with long signal frames. This problem is particularly prominent. Therefore, a signal receiving device which can improve the precision of frequency offset compensation is urgently needed.

### SUMMARY OF THE INVENTION

Based on this, it is necessary to provide a signal receiving device, communication system and signal receiving method.

A signal receiving device comprises:

Receiving module for receiving communication signals;

A first filter, connected with the receiving module, is used to filter the communication signal to obtain the first signal;

A second filter connected with the receiving module for filtering the communication signal to obtain a second signal, the frequency band width of the second filter is lower than that of the first filter;

a frequency offset estimation module connected with the second filter is used to obtain a frequency offset estimate based on the second signal;

frequency offset compensation module, respectively connected with the first filter, the frequency offset estimation module and the signal processing terminal, for frequency offset compensation of the first signal according to the frequency offset estimate and transmission to the signal processing terminal.

In one embodiment, the communication signal includes a long training code field, the frequency band of the second filter, the width matches the frequency band width of the long training code field.

In one of the embodiments, the first filter is a higher-order linear phase filter and the second filter is a low order nonlinear phase filter.

In one embodiment, the communication signal includes a data frame field, the frequency band width of the first filter matches the frequency band width of the data frame field.

In one of the embodiments, the receiving module comprises:

antenna for receiving radio frequency signals;

Radio frequency circuit, respectively connected to the antenna, the first filter and the second filter, for transmitting radio frequency, the signal is converted into an electrical signal to be used as the communication signal and transmitted to the first filter and the second filter respectively device.

In one embodiment, the signal receiving device also includes:

An analog-to-digital conversion module, respectively connected with the RF circuit, the first filter and the second filter, is used to convert the communication signal from an analog signal to a digital signal and transmit it to the first filter and the second filter respectively.

In one embodiment, the signal receiving device also includes:

Fourier converter, respectively connected with the frequency offset compensation module and the signal processing terminal, is used to convert the first signal from the time domain to the frequency domain and transmit it to the signal processing terminal.

In one of the embodiments, the frequency offset compensation module is a mixer.

A communication system consisting of:

Signal processing terminal; As well as

The signal receiving device of any of the above.

A signal receiving method includes:

Receive communication signals;

The first signal is obtained by filtering the communication signal with the first filter, wherein the first filter is higher order filter;

A second filter is used to filter the communication signal to obtain a second signal, wherein the second filter's frequency band width is lower than that of the first filter;

An estimated frequency offset is obtained from the second signal and the first signal is fed from the estimated frequency offset partial compensation.

The signal receiving device is provided with a receiving module, a first filter, a second filter, a frequency offset estimation module and a frequency. The offset compensation module receives the communication signal through the receiving module, and then the first filter filters the communication signal to get the first signal, the second filter filters the communication signal to obtain the second signal, wherein the second filter frequency band width is lower than the first band width of the first filter, so that because the band width of the second filter is narrower, the noise to interference ratio of the second signal. The noise interference of the first signal is less, so the frequency offset estimation module is used to estimate the frequency offset of the second signal, and the frequency offset is obtained. The estimated value is more accurate, and the frequency offset compensation module can compensate the first signal more accurately based on the estimated value.

### BRIEF DESCRIPTION OF THE DRAWINGS

in order to more clearly explains the application example or technical scheme of the traditional technology, the following described for example or the traditional technology of the appended drawings of the need to use introduce simply, clearly, described below the appended drawings is just this application, some of the cases, for the field common technical personnel, on the premise of not giving creative labor, Additional drawings can also be obtained from these drawings.

FIG. 1 shows a schematic diagram of the signal receiving device of an embodiment;

FIG. 2 is a schematic diagram of a signal receiving device for another embodiment;

FIG. 3 is a schematic diagram of a signal receiving device for another embodiment.

### Component Label Description

Receiving module: 101; The first filter: 102; Second filter: 103; Frequency offset estimation module: 104; Frequency offset compensation module: 105; Signal processing terminal: 106; Antenna: 107; Rf circuit:

108; Analog to digital conversion module: 109

### DETAILED DESCRIPTION OF THE INVENTION

In order to facilitate the understanding of this application, a more comprehensive description of this application is provided below with reference to the relevant attached drawings. Embodiments of this application are given in the attached drawings. However, this application can be implemented in many different forms and is not limited to the embodiments described herein. Rather, the purpose of providing these embodiments is to make the disclosure of this application more thorough and comprehensive.

Unless otherwise defined, all technical and scientific terms used herein have the same meaning as those normally understood by a person skilled in the technical field of this application. The terms used herein in the specification of this application are only for the purpose of describing specific embodiments and are not intended to restrict this application.

It is understood that the terms “first”, “second” etc. used in this application may be used herein to describe various components, but such components are not subject to these terms. These terms are used only to distinguish the first element from another. For example, without leaving the scope of this application, the first resistor may be referred to as the second resistor, and similarly the second resistor may be referred to as the first resistor. The first resistor and the second resistor are both resistors, but they are not the same resistance.

It is understood that “connection” in the following embodiments shall be construed as “electrical connection”, “communication connection”, etc., if the connected circuits, modules, units, etc., have electrical or signal transmission between them.

When used here, the singular forms “one”, “one”, and “said/the” may also include the plural, unless the context clearly indicates otherwise. Also should understand is that the term “includes/include” or “has” specifies the stated characteristics, overall, steps, operating, the existence of the components, parts, or their combination, but does not exclude the existence or add one or more other features, overall, steps, operating, components, parts, or the possibility of the combination of them. Also, the terms “and/or” used in this specification include any and all combinations of the items listed.

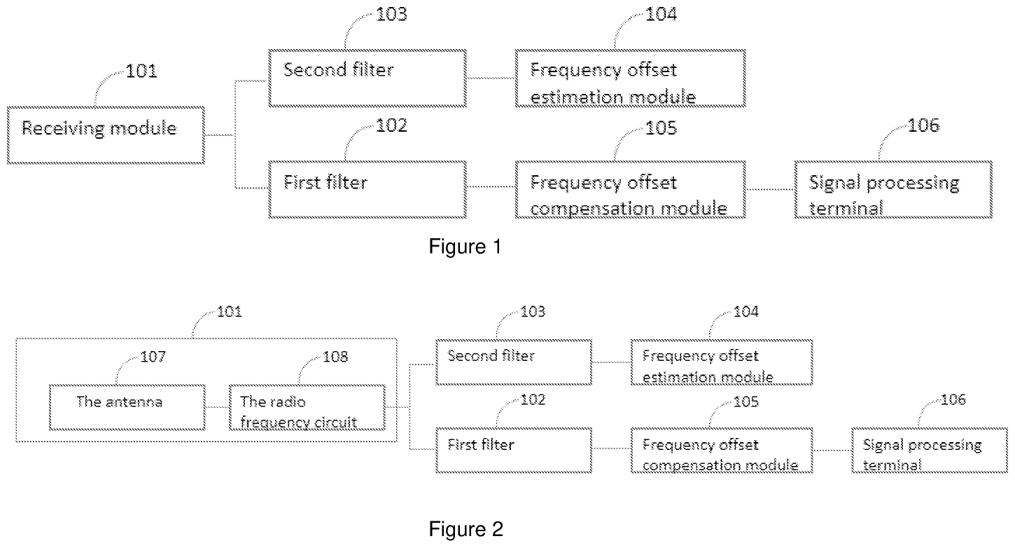

FIG. 1 is a schematic diagram of the signal receiving device of an embodiment, as shown in FIG. 1. The signal receiving device includes a receiving module 101, a first filter 102, a second filter 103, a frequency offset estimation module 104 and a frequency offset compensation module 105, among which the receiving module 101 is used to receive communication signals. The first filter 102 is connected with the receiving module 101, which is used to filter the communication signal to get the first signal; The second filter 103 is connected with the receiving module 101 to filter the communication signal and get the second signal. The frequency band width of the second filter 103 is lower than that of the first filter 102.

The frequency offset estimation module 104 is connected with the second filter 103, which is used to obtain the frequency offset estimation according to the second signal. The frequency offset compensation module 105 is connected with the first filter 102, the frequency offset estimation module 104 and the signal processing terminal 106 respectively, which is used to compensate the frequency offset of the first signal according to the frequency offset estimation value and then transmitted to the signal processing terminal 106.

Among them, the receiving module 101 can receive communication signals wirelessly. Since the communication signals are exposed in the wireless space, they are easily affected by external adjacent interference, so the first filter 102 can be set to filter the communication signals. The first filter 102 can be a broadband filter with high signal-to-noise ratio (SNR) characteristics. It can effectively filter out the adjacent interference information in the communication signal and obtain the first signal with high SNR, thus meeting the high SNR requirement of the late signal processing terminal 106 when the carrier signal is demodulated. The second filter 103 can be a narrow band filter whose frequency band width is lower than that of the first filter 102. As its frequency band width is narrower, it can filter out more interference information in the communication signal and obtain a more pure second signal. Furthermore, the frequency offset estimation module 104 can obtain a more accurate frequency offset estimation value based on the second signal.

Further, after obtaining the estimated frequency offset value, the first signal can be compensated by frequency offset compensation module 105 and transmitted to signal processing terminal 106. Specifically, the frequency offset compensation module 105 can modify the frequency of the first signal according to the estimated frequency offset, so as to improve the frequency offset of the first signal.

The signal receiving device of the embodiment of the invention is provided with a receiving module 101, a first filter 102, a second filter 103, a frequency offset estimation module 104 and a frequency offset compensation module 105. The receiving module 101 receives the communication signal, and then the first filter 102 filters the communication signal to obtain the first signal. The second filter 103 filters the communication signal to obtain the second signal, among which the frequency band width of the second filter 103 is lower than that of the first filter 102. Therefore, the frequency offset estimation module 104 is used to estimate the frequency offset of the second signal, and the obtained frequency offset estimation value is more accurate. Finally, the frequency offset compensation module 105 compensates the first signal based on the estimated frequency offset.

In one embodiment, the communication signal includes a long training code field, and the frequency band width of the second filter 103 matches that of the long training code field.

It is understood that communication signals may be based on packet formats specified in the IEEE 802.11 wireless standard, including preamble codes, The leading code can be divided into three parts: Short Training Field(STF), Long Training Field(LTF) and Signal Field(SIG). Frequency offset estimation module code 104 is the use of long training LTF for CFO of carrier frequency offset estimation, concrete, is to use since the correlation of the LTF long training yards in the time domain to frequency offset estimation, so the second filter bandwidth can be set to 103 and the band width of long training code field match, so as to maximize the accuracy of the frequency offset estimation.

In one embodiment, the first filter 102 May be a high-order linear phase filter, and the second filter 103 May be a low-order nonlinear phase filter.

It is understood that the high-order linear phase filter can meet the high SNR requirement of signal processing terminal 106, which makes the processed communication signal have a higher SNR and better meet the high SNR requirement of signal processing terminal 106. When using the autocorrelation of LTF long training code in the time domain to make frequency offset estimation, Due to long training yards LTF in time domain of the filter linearity relation with the correlation, and considering the bandwidth needs and training yards long field match, so can use of low order nonlinear phase filter processing to get the second signal, thus the second signal frequency offset estimation, eventually making deviation compensation accuracy is higher, closer to the sender sends a signal,

Realize carrier synchronization. Moreover, the price of low-order nonlinear phase filter is lower than that of high-order linear phase filter, so using low-order nonlinear phase filter can save cost.

In one embodiment, the communication signal includes a data frame field, and the band width of the first filter 102 matches that of the data frame field.

It can be understood that the communication signal based on the packet format specified in IEEE 802.11 wireless standard also includes the data frame field. The first filter 102, which matches the frequency band width of the data frame field, is used to filter the communication signal and ensure the integrity of the data frame field. Will not be lost by the first filter 102 processing.

For example, In IEEE 802.11n HT (a.ka. WiFi 4) protocol and IEEE 802.11ac VHT (a.k.a. WiFi5) protocol, the frequency band width of the long training code field and data frame field is 1.6.5 5 M H z (=312 0.5 kHz*52=16.25 MHz) and 17.5 MHz (=312.5 kHz*56=17.5 MHz), That is, the band width of the system data frame field in WiFi 4 and WiFi5 is 7.7% more than the band width of the long training code field (17.5 MHz/16.25 MHz 1=7.07%). If only the first filter 102 is used to process the communication signal, Then, frequency offset estimation and frequency offset compensation are carried out on the processed communication signals respectively. The accuracy of frequency offset estimation will be reduced due to the 7.7% noise. Therefore, the second filter 103, which matches the frequency band width with the frequency band width of the long training code field, and the frequency band width can be used respectively. The first filter 102, whose degree matches the band width of the data frame field, separately processes the communication signal to obtain the first signal and the second signal respectively.

The frequency band width of the long training code field and the data frame field stipulated in IEEE 802.11ax HE(a.k.a. WiFi 6) protocol standard is 16.25 MHz (=3125 khz*52=16.25 MHz) and 19.06 MHz (=78), respectively 0.125 khz*244=19.06 MHz), that is, the bandwidth of the system data frame field in WiFi 6 is 17.3% higher than that of the long training code field, which is only 7.7% higher than that of WiFi 4 and WiFi 5. The gap between the frequency band width of the long training code field and the data frame field in WiFi 6 is larger. In addition, because the subcarrier interval of WiFi 6 data frame field is only one quarter of the subcarrier interval of WiFi 3/4/5, and compared to the star-chart 256 QAM of WiFi 5 and the star-chart 256 QAM of WiFi 4, the star-chart of WiFi 6 is 1024 QAM, So WiFi 6 precision requirement for frequency offset estimation is higher than WiFi 4 and WiFi 5 many, so if only the first filter 102 to deal with communication signals, then the processed signal to frequency offset estimation and frequency offset compensation respectively, eventually lead to the receiving terminal receives the signal reduced signal to noise ratio and data throughput.

FIG. 2 is a schematic diagram of the signal receiving device of another embodiment, as shown in FIG. 2. The receiving module 101 includes antenna 107 and RF circuit 108. Antenna 107 is used to receive RF signals. The RF circuit 108 is connected to the antenna 107, the first filter 102 and the second filter 103 respectively to convert the RF signal into an electrical signal for communication and transmission to the first filter 102 and the second filter 103 respectively.

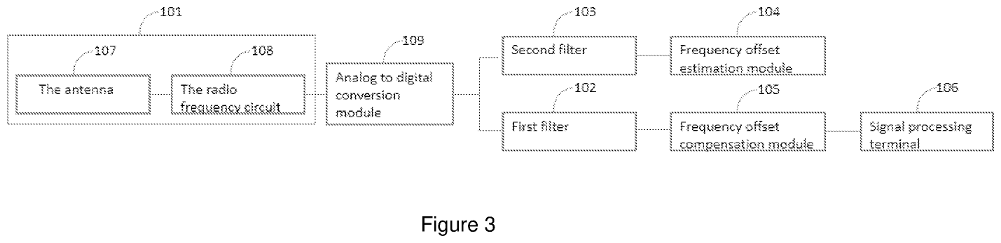

In one embodiment, the signal receiving device also includes the analog-to-digital conversion module 109, as shown in FIG. 3. The analog-to-digital conversion module 109 is connected to the RF circuit 108, the first filter 102, and the second filter 103, respectively, for converting communication signals from analog to digital signals. And transmitted to the first filter 102 and the second filter 103 respectively.

In one embodiment, the signal receiving device also includes a Fourier converter (not identified) connected to a frequency offset compensation module 105 and a signal processing terminal 106, respectively, for converting the first signal from the time domain to the frequency domain and transmitting it to the signal processing terminal 106.

It is understandable that in the multi-carrier modulation of the communication signal, the communication signal after frequency offset compensation needs to be converted from the time domain to the frequency domain, so as to be further transmitted to the signal processing terminal 106 for data demodulation.

In one embodiment, the frequency offset compensation module 105 can be a mixer.

Embodiments of the invention also provide a communication system, including a signal processing terminal 106; And the signal receiving device of any of the above embodiments.

Embodiments of the invention also provide a signal receiving method, including the following steps:

Step S110, receive the communication signal.

Wherein, the communication signal can be received by means of wireless communication, for example, antenna 107 assembly including antenna 107 and RF circuit 108 can be adopted.

Step S120, the first signal is obtained by filtering the communication signal with the first filter 102.

as exposed to the wireless communication signal space, vulnerable to external adjacent frequency interference, so the communication signal filter can be set up the first filter 102, 102 the first filter for wide band filter, its high signal-to-noise ratio characteristics, can efficiently filter out communication signals in adjacent frequency interference information, the first signal with high signal-to-noise ratio, Thus, it can meet the high SNR requirement of the late signal processing terminal 106 when the carrier signal is demodulated.

Step S130, the second filter 103 is used to filter the communication signal to get the second signal, in which the frequency band width of the second filter 103 is lower than that of the first filter 102.

The second filter 103 can be a narrow band filter with a frequency band width lower than the first filter 102. Because of its narrower frequency band width, it can filter out more interference information in the communication signal and obtain a cleaner second signal. In addition, the frequency offset estimation module 104 can obtain a more accurate frequency offset estimation based on the second signal.

In step S140, the estimated frequency offset is obtained according to the second signal, and the estimated frequency offset is used to compensate the forward frequency offset of the first signal and transmitted to the signal processing terminal 106.

The embodiment of the invention receives the communication signal, and then uses the first filter 102 to filter the communication signal to obtain the first signal, and uses the second filter 103 to filter the communication signal to obtain the second signal, wherein the frequency band width of the second filter 103 is lower than that of the first filter 102. The noise interference of the second signal is less than that of the first signal. Therefore, the frequency offset estimation module 104 is used to estimate the frequency offset of the second signal, and the frequency offset estimation value is more accurate.

In one embodiment, the communication signal may include a long training code field, and the frequency band width of the second filter 103 May match that of the long training code field.

It is understood that the communication signal may be based on the packet format specified in the IEEE 802.11 wireless standard, including the lead Code (preamble), the leading code can be divided into Short Training Field (STF) and long training field (LTF) and Signal Field(SIG) of these three parts, frequency offset estimation module 104 is using long LTF training code is used to perform CFO carrier frequency offset estimation. Specifically, LTF long training code is used to perform autocorrelation in the time domain. Therefore, the band width of the second filter 103 can be set to match the band width of the long training code field, and maximize the accuracy of frequency offset estimation.

In one embodiment, the first filter 102 May be a higher-order linear phase filter, and the second filter 103 May be Low order nonlinear phase filter.

Understandably, the higher order linear phase filter can meet the high signal-to-noise ratio requirements of signal processing terminal 106, so that the communication signal after management has a higher signal-to-noise ratio, which is more in line with the high signal-to-noise ratio requirement of signal processing terminal 106, and passes the LTF long training code. In the time domain autocorrelation for frequency offset estimation, because the long training code LTF autocorrelation in the time domain on the phase line of the filter. The requirement of sex degree is low, and considering the frequency band width needs to match the long training code field, low order nonlinear phase can be adopted. The second signal is processed by the filter, and then the frequency offset of the second signal is estimated. Finally, the precision of frequency offset compensation is higher. Closer to the communication signal sent by the sender to realize carrier synchronization. And the lower order nonlinear phase filter is compared to the higher order line. The price of sex-phase filter is lower, and the use of low-order nonlinear phase filter can save the cost.

In one embodiment, the communication signal includes the data frame field, the band width of the first filter 102, and the data frame field's band width matches.

It is understood that communication signals based on the packet format specified in the IEEE 802.11 wireless standard also include data frame field, the communication signal is filtered by the first filter 102, which matches the frequency band width with that of the data frame field wave processing, to ensure the integrity of the data frame field, will not be lost by the first filter 102 processing.

In one embodiment, the step of receiving a communication signal also includes receiving an RF communication signal and transmitting the RF message signals are converted into electrical signals to be used as communication signals and transmitted to the first filter 102 and the second filter 103 respectively.

In one embodiment, after the RF signal is converted into an electrical signal to be used as a communication signal, the signal receiving method is returned Including the conversion of a communication signal from an analog signal to a digital signal.

In one embodiment, after compensating the first signal for frequency offset according to the estimated frequency offset, the signal receiving method also includes the conversion of the first signal from the time domain to the frequency domain and transmission to the signal processing terminal 106.

It can be understood that in the multi-carrier modulation of the communication signal, the communication signal after frequency offset compensation needs to be timed. The domain is converted to the frequency domain for further transmission to signal processing terminal 106 for data demodulation.

In the description of this specification, reference is made to the terms “some embodiments”, “other embodiments”, “ideal embodiments”, etc. Description means that the specific features, structures, materials or features described in conjunction with the embodiment or example are at least contained in the present invention.

The technical characteristics of the above embodiments may be arbitrarily combined. For the sake of conciseness of description, the above realities are not described. All possible combinations of the various technical characteristics in the application are described, however, as long as no combination of these technical characteristics exists. Any contradiction shall be considered to be within the scope of this specification.

The above embodiments express only a few embodiments of the invention, which are described in a more specific and detailed way, but cannot be construed as a limitation of the scope of the invention patent. It should be noted that for ordinary technicians in this field. On the premise of not deviating from the conception of the invention, a number of deformation and improvement can be made, which belong to the protection scope of the invention. Therefore, the scope of protection of the invention shall be subject to the attached claims.

What is claimed is:

1. A signal receiving device is characterized by:
a receiving module for receiving communication signals;
a first filter, connected with the receiving module, used to filter the communication signal to obtain the first signal;
a second filter, connected with the receiving module, used to filter the communication signal to obtain a second signal, wherein the frequency band width of the second filter is lower than that of the first filter;
a frequency offset estimation module connected with the second filter is used to obtain a frequency offset estimate based on the second signal;
the frequency offset compensation module is respectively connected with the first filter, the frequency offset estimation module and the signal processing terminal for the first signal is compensated according to the estimated frequency offset value and transmitted to the signal processing terminal;
the communication signal includes a long training code field, the frequency band width of the second filter and the long training code field frequency band width matching.

2. According to the signal receiving device described in claim 1, the characteristic is that the first filter is of a higher order linear phase filter, the second filter is a low order nonlinear phase filter.

3. According to claim 2, the signal receiving device is characterized by the fact that the communication signal includes a data frame field, the band width of the first filter matches the band width of the data frame field.

4. According to the signal receiving device mentioned in claim 1, its characteristics lie in that the receiving module includes:
an antenna for receiving radio frequency signals;
the radio frequency circuit is respectively connected with the antenna, the first filter and the second filter for transmitting the radio frequency signal converted into an electrical signal to be used as the communication signal and transmitted to the first filter and the second filter respectively.

5. The signal receiving device mentioned in claim 4 is characterized by the fact that the signal receiving device also includes:
an analog-to-digital conversion module, respectively, is connected with the RF circuit, the first filter and the second filter for the communication signal is converted from an analog signal to a digital signal and transmitted to the first filter and the second filter respectively device.

6. According to claim 1, the signal receiving device is characterized by the fact that the signal receiving device also includes:
a Fourier converter, respectively connected with the frequency offset compensation module and the signal processing terminal, is used to bring the first signal is converted from the time domain to the frequency domain and transmitted to the signal processing terminal.

7. According to the signal receiving device mentioned in claim 1, its feature is that the frequency offset compensation module is a mixer.

8. A communication system characterized by:
Signal processing terminal; As well as
The signal receiving device of any of the claim 1.

9. A signal reception method is characterized by:
receiving communication signals;
a first signal is obtained by filtering the communication signal with the first filter, wherein the first filter is a high order filter;
a second filter is used to filter the communication signal to obtain a second signal, wherein the frequency band of the second filter width is lower than the frequency band width of the first filter;
an estimated frequency offset is obtained from the second signal and the first signal is supplemented by the estimated frequency offset compensation;
the communication signal includes a long training code field, the frequency band width of the second filter and the long training code field frequency band width matching.
